(19) United States
(12) Patent Application Publication
(10) Pub. No.: US 2026/0057239 A1
(43) Pub. Date: Feb. 26, 2026

(54) METHOD AND DEVICE FOR TRAINING A MACHINE LEARNING MODEL, IN PARTICULAR A GENERATIVE MACHINE LEARNING MODEL

(71) Applicant: Robert Bosch GmbH, Stuttgart (DE)

(72) Inventor: Kilian Rambach, Stuttgart (DE)

(21) Appl. No.: 19/274,708

(22) Filed: Jul. 21, 2025

(30) Foreign Application Priority Data
Jul. 22, 2024 (DE) 10 2024 206 882.9

(51) Int. Cl. G06N 3/088; G01S 13/58; G01S 13/89; G06N 3/0455; G06N 3/0475

(52) U.S. Cl. CPC G06N 3/088; G01S 13/58; G01S 13/89; G06N 3/0455; G06N 3/0475

(57) ABSTRACT

A method and a device for training a machine learning mode, including a generative machine learning model, for object detection.

### FIELD

The present invention relates to a method and a device for training a machine learning model for object detection.

### BACKGROUND INFORMATION

Modern technologies such as Advanced Driver Assistance Systems (ADAS) and Autonomous Driving (AD) require precise detection and representation of the environment. For this purpose, radar sensors are used in addition to cameras and lidar sensors. These sensors provide measurement data in the form of point clouds, in which each point is described by various properties such as distance, azimuth angle, Doppler velocity, radar cross section and elevation angle or by Cartesian coordinates (x, y, z).

In addition to the spatial dimensions (distance, azimuth and elevation angles), radar sensors also offer the possibility of measuring Doppler velocity and are characterized by high resolution in doing so. Lidar sensors that are appropriately equipped and operated can also detect the Doppler dimension. These point clouds are then processed to detect or classify objects, for example.

One step in data processing is calculating the similarity between two point clouds. This requires a suitable metric that can determine the distance between two points. Generative models such as autoencoders that generate point clouds require such a metric to be able to be trained. The current related art uses the Cartesian coordinates (x, y, optionally z) of the points to measure distance. These distances are then used within the framework of the Chamfer distance and/or the Hausdorff distance to identify pairs of points with minimal distance. Radar-specific attributes such as Doppler velocity and Radar Cross Section (RCS) are then taken into account to calculate the differences between the corresponding points.

The Hausdorff metric calculates the distance between two sets A and B. The smaller the distance, the more similar the sets A and B are. Thus, this metric can be applied to point clouds. For this purpose, the distance D (x, K) is defined, which calculates the distance between a point x and the set k:

$$D ( x , K ) = {min}_{k ∈ K} d ( x , k )$$

It is the distance of the point x to the point k which has the minimum distance to x. For this purpose, a suitable metric d (x, k) is required, which calculates the distance between two points x and k.

The Hausdorff distance is defined as:

$$δ \text{?} ( A , B ) = max \{ {max}_{a ∈ A} D ( a , B ) , {max}_{b ∈ B} D ( b , A ) \}$$

$$\text{?} \text{indicates text missing or illegible when filed}$$

In other words, the point a is sought that has the maximum distance to the set B and vice versa, and the maximum of it is taken. To calculate the Hausdorff distance, the distance between at least two points must be calculated.

In the Chamfer distance, the distance between two point clouds A, B is defined as:

$$δ \text{?} ( A , B ) = \frac{1}{\vert A \vert} {\sum }_{a ∈ A} {max}_{b ∈ B} d ( a , b ) + \frac{1}{\vert B \vert} {\sum }_{b ∈ B} {max}_{a ∈ A} d ( a , b )$$

$$\text{?} \text{indicates text missing or illegible when filed}$$

By using the notation used previously, the following is obtained:

$$δ \text{?} ( A , B ) = \frac{1}{\vert A \vert} {\sum }_{a ∈ A} D ( a , B ) + \frac{1}{\vert B \vert} {\sum }_{b ∈ B} D ( a , A )$$

$$\text{?} \text{indicates text missing or illegible when filed}$$

Here as well, the distance d (a, b) between two points a and b is required.

Overall, the accurate and efficient calculation of the similarity between point clouds represents a challenge for the further development of ADAS and autonomous driving systems.

It is an object of the present invention to specify a method and/or a device that are improved in this regard.

The object may be achieved by a method according to certain features of the present invention. The object may also be achieved by a device according to certain features of the present invention.

### SUMMARY

According to a first aspect, a method for training a machine learning model for object detection is provided. According to an example embodiment of the present invention, the methos includes the following steps:
providing Doppler effect velocity information of a relative radial velocity of at least one point of an input point cloud of an object to be detected, measured in relation to a detecting sensor, and geometric information about the at least one point of the input point cloud, wherein the machine learning model generates at least one point of an output point cloud based on the Doppler effect velocity information and/or the geometric information, wherein Doppler effect velocity information of the relative radial velocity of the at least one point of the object to be detected, measured in relation to the detecting sensor, and geometric information are assigned to the at least one point of the output point cloud;
calculating a distance between the at least one point of the input point cloud and the at least one point of the output point cloud on the basis of the corresponding Doppler effect velocity information and the corresponding geometric information, in particular by using a metric;
optimizing the generative machine learning model by optimizing a cost function by using a metric incorporating the calculated distance and optionally by using the Doppler effect velocity information; and
providing the trained machine learning model.

It is understood that the steps according to the present invention, as well as other optional steps, do not necessarily have to be carried out in the order shown, but can also be carried out in a different order. Other intermediate steps can also be provided. The individual steps can also comprise one or more sub-steps without departing from the scope of the method according to the present invention.

According to a second aspect of the present invention, a device for training a machine learning model for object detection is provided. According to an example embodiment of the present invention, the device includes an evaluation and computing unit that is designed to carry out the following steps:
providing Doppler effect velocity information of a relative radial velocity of at least one point of an input point cloud of an object to be detected, measured in relation to a detecting sensor, and geometric information about the at least one point of the input point cloud, wherein the machine learning model generates at least one point of an output point cloud based on the Doppler effect velocity information and/or the geometric information, wherein Doppler effect velocity information of the relative radial velocity of the at least one point of the object to be detected, measured in relation to the detecting sensor, and geometric information are assigned to the at least one point of the output point cloud;
calculating a distance between the at least one point of the input point cloud and the at least one point of the output point cloud on the basis of the corresponding Doppler effect velocity information and the corresponding geometric information, in particular by using a metric;
optimizing the generative machine learning model by optimizing a cost function by using a metric incorporating the calculated distance and optionally by using the Doppler effect velocity information; and
providing the trained machine learning model.

The explanations given for the method of the present invention apply accordingly to the device of the present invention. It is understood that linguistic modifications of features formulated for the method can be reformulated for the device in accordance with standard linguistic practice, without such formulations having to be explicitly listed here.

According to an example embodiment of the present invention, the dimension of the Doppler effect velocity information is preferably used directly in the metric to calculate the distance between a point of an input point cloud and a point of an output point cloud, instead of using only geometric information, such as coordinate indications x, y or x, y, z. In the present disclosure, the term Doppler effect velocity information is also abbreviated as “Doppler.”

In contrast to the related art, the Doppler effect velocity information is thus used directly to calculate the distance between a point of an input point cloud and a point of an output point cloud.

The method of the present invention can improve the training of a machine learning model, in particular a generative machine learning model, leading to better generative models that can, for example, better reconstruct a distribution of point clouds. The method of the present invention can also be used as a basis for evaluating how similar two point clouds are to each other. This allows an evaluation that is more powerful for comparing point clouds from radar and/or lidar sensors.

The phrase “by using a metric incorporating the calculated distance” means that, in addition to the calculated distance, preferably the Doppler effect velocity information and/or the geometric information about the at least one point can also be used as further input data for optimizing the machine learning model.

In a further aspect of the present invention, it is provided that the Doppler effect velocity information and geometric information of the at least one point of the input point cloud are detected by an optical sensor that is movable relative to the object, in particular a lidar sensor, a radar sensor or an ultrasonic sensor, and/or are generated by synthetic data generation.

Radar and/or lidar sensors can preferably measure the Doppler effect velocity information directly. The Doppler effect velocity information preferably corresponds to a relative radial velocity of a point measured by the sensor in relation to the sensor. For many applications, Doppler effect velocity information is an important variable which allows, for example, an estimation of a velocity of road users in autonomous driving and/or the classification of objects based on a so-called micro-Doppler effect. The Doppler effect velocity information and geometric information of the at least one point can also be provided by synthetic data generation, for example by simulating a radar and/or lidar sensor.

According to an example embodiment of the present invention, the sensors preferably measure in the dimensions distance, Doppler effect velocity information, azimuth angle and elevation angle. Therefore, it can be useful to take these additional measurement dimensions into account when calculating a distance between two points. This was recognized by the inventors in this case. Radar and/or lidar sensors have a high resolution in the Doppler effect velocity information dimension. In order to determine the distance between two points in a measuring space of the sensor, it is therefore advantageous to directly also take into account the Doppler effect velocity information dimension. This point in particular was recognized by the inventors.

In a further aspect of the present invention, it is provided that geometric information comprises information about Cartesian coordinates of the corresponding at least one point and/or information about a subset of the Cartesian coordinates of the corresponding at least one point and/or information about a distance from an optical sensor and/or information about an azimuth angle and/or elevation angle.

Thus, let the corresponding at least one point be given, for example, a, b. The corresponding at least one point comprises attributes (geometric attributes) that describe the position of the points, in particular relative to a predetermined, preferably common, coordinate system.

In addition, the corresponding at least one point has in each case as an attribute an item of Doppler effect velocity information (i.e. an item of information about a relative radial velocity with respect to a radar and/or lidar sensor).

In a further aspect of the present invention, it is proposed that the machine learning model comprises a variable autoencoder and/or an autoencoder for point clouds.

The proposed at least one metric can preferably be used to optimize an autoencoder or a variable autoencoder. The autoencoder preferably comprises an encoder that encodes input data, for example the input point cloud, i.e. that calculates a representation in a latency space of the point cloud. A decoder of the autoencoder converts the representation in the latency space back into an output point cloud. To train the model, a loss value is calculated. This loss value indicates how big the difference is between the generated (decoded) point cloud and a reference point cloud, which is usually the input data. For the calculation of the loss value, it is also possible to consider only parts of the generated point cloud and/or parts of the reference point cloud. To calculate the loss value, the point clouds must be compared with each other. The proposed invention, as a result of the improved way of calculating the distance between two points, can be used for this purpose.

In a further aspect of the present invention, it is provided that the generative machine learning model is trained to compare multiple input point clouds with one another, wherein the input point clouds, in particular a similarity between the input point clouds, can be evaluated on the basis of the calculated distance, and/or wherein the generative machine learning model is trained to generate and/or predict at least one further point cloud on the basis of an input reference point cloud, wherein the generation and/or prediction of the reference point cloud is carried out on the basis of the metric incorporating the calculated distance.

In a further aspect of the present invention, it is provided that the Doppler effect velocity information and the geometric information about the at least one point of the input point cloud (204) are provided from a home vehicle, wherein the Doppler effect velocity information is preprocessed such that it is compensated for by a movement of a home vehicle, or wherein the Doppler effect velocity information is preprocessed such that it is divided into at least two velocity components of the home vehicle.

Alternatively or additionally, the corresponding Doppler effect velocity information can be further processed in a data preprocessing step. For example, in a vehicle-specific application, the Doppler effect velocity information can be compensated for by the movement of the home vehicle. Data collection is preferably carried out from this home vehicle. Alternatively, the Doppler effect velocity information can be divided into two or three (spatial) components of the Doppler effect velocity with respect to a given coordinate system, e.g. vₓ, v_{y}, v_{z}.

In a further aspect of the present invention, it is provided that the Doppler effect velocity information and geometric information are each normalized.

The geometric coordinates are measured in a different physical unit than the Doppler effect velocity information. For example, the Cartesian coordinates x, y of a point in meters and the Doppler effect velocity in m/s. As another example, a distance r of a point to the sensor is measured in meters, an azimuth angle in degrees, and the Doppler effect velocity information in m/s. Due to these differences, it is preferable to normalize the components involved in the distance calculation by prefactoring wᵢ. The geometric attributes and the Doppler attributes of a point a can be described by aᵢ, i=1, . . . . N. Here N is the total number of geometric attributes, Doppler attributes and any other attributes. As an example for the dimensions (x, y, Doppler), N=3.

Based on this, the distance between two points a, b can be calculated by using a norm or metric, such as the Lip norm or the maximum norm.

Below, such a metric for calculating the distance is designated d_{doppler}.

The following applies to the Lₚ norm:

$${d}^{doppler} ( a , b ) = {( {{\sum }_{i = 1}}^{N} {\vert {w}_{i} ( {a}_{i} - {b}_{i} ) \vert}^{p} )}^{1 / p}$$

With 1≤p<∞. For p=2, this is the Euclidean norm.

The following applies to the maximum norm:

$${d}_{max}^{doppler} ( a , b ) = {max}_{i = 1 , … , N} \vert {w}_{i} ( {a}_{i} - {b}_{i} ) \vert$$

The weights wᵢ of the maximum norm can be determined in different ways. The weights, or a portion of the weights, can be fixedly specified. When training a neural network, these are hyperparameters. Some of the weights can also be set to 1, e.g. for the Cartesian coordinates x, y. For the other weights, there are multiple options. The weights for the geometric coordinates and for the Doppler attribute(s) can be chosen from physical considerations and from the choice of which weight the Doppler attributes should have compared to the geometric attributes. If the metric is used in the context of training a neural network, the weights can be determined by hyperparameter tuning. For example, multiple training sessions are carried out with different weights and the best hyperparameters are selected. If polar or spherical coordinates are used, the coordinates can optionally also be transformed into Cartesian coordinates or an equivalent formula can be used.

The weights wᵢ or a portion of the weights wᵢ can alternatively be determined by normalizing the N attributes over a set of data being considered, so that each attribute has a certain variance, e.g. variance=1, over the data considered. The variance values can be chosen differently for each attribute, e.g. to weight the Doppler dimension more or less strongly. The data considered can be a data sample, i.e. a recorded measurement including multiple points of a point cloud. The data under consideration can be a batch of data, i.e. a set of data samples. This can be, for example, a current batch that is used during training of a neural network. The data under consideration can be available as a complete data set for training.

Furthermore, one or more weights wᵢ can be learnable parameters. The learnable parameters are optimized, for example, during the training of the neural network, analogously to the weights in the neural network. The methods mentioned above can be used for initialization.

In a further aspect of the present invention, it is provided that the calculation of a distance between the corresponding at least one point is further carried out on the basis of further features, in particular a reflection intensity or a radar cross section.

The points can also have additional attributes (features), such as the reflection intensity for lidar sensors or the radar cross section (RCS) for radar sensors. The further attributes of a point a are aᵢ^{feat}, with i=1, . . . . M. Then the difference in the other attributes between two points a, b can be calculated analogously to the above.

The following applies to the Lₚ norm:

$${d}^{feat} ( a , b ) = {( {{\sum }_{i = 1}}^{M} {\vert {w}_{i}^{feat} ( {a}_{i}^{feat} - {b}_{i}^{feat} ) \vert}^{p} )}^{1 / p}$$

The following applies to the maximum norm:

$${d}_{max}^{feat} ( a , b ) = {max}_{i = 1 , … , M} \vert {w}_{i}^{feat} ( {a}_{i}^{feat} - {b}_{i}^{feat} ) \vert$$

The weights wᵢ^{feat} can be defined or learned analogously in one of the ways described above.

Particularly preferably, the entire metric can be obtained by combining the Doppler metric and the feature metric.

$$d \text{?} ( a , b ) = {d}^{doppler} ( a , b ) + {d}^{feat} ( a , b )$$

$$\text{?} \text{indicates text missing or illegible when filed}$$

In a further aspect, it is proposed that the metric is based on a Chamfer distance metric or a Hausdorff distance metric.

The proposed metrics can now be used for the Chamfer or Hausdorff distance metric. There are several ways to do this. The Hausdorff or Chamfer metrics can also be used to compare a subset of points from two point clouds. The metrics can also be used to evaluate how well synthetically generated point clouds perform by comparing them with real measured point clouds.

To calculate the Chamfer distance metric between two point clouds A, B, the Doppler metric is used for d (a, b). That is, in addition to the geometric attributes, the Doppler attributes are also used to determine the nearest points.

For the Lₚ norm, this yields:

$$δ \text{?} ( A , B ) = \frac{1}{\vert A \vert} {\sum }_{a ∈ A} {min}_{b ∈ B} d \text{?} ( a , b ) + \frac{1}{\vert B \vert} {\sum }_{b ∈ B} {min}_{a ∈ A} {d}^{doppler} ( a , b )$$

$$\text{?} \text{indicates text missing or illegible when filed}$$

This yields the maximum norm:

$$δ \text{?} ( A , B ) = \frac{1}{\vert A \vert} {\sum }_{a ∈ A} {min}_{b ∈ B} d \text{?} ( a , b ) + \frac{1}{\vert B \vert} {\sum }_{b ∈ B} {min}_{a ∈ A} d \text{?} ( a , b )$$

$$\text{?} \text{indicates text missing or illegible when filed}$$

To determine the nearest points, all attributes of the points are now preferably used. The following applies:

$$δ \text{?} ( A , B ) = \frac{1}{\vert A \vert} {\sum }_{a ∈ A} {min}_{b ∈ B} d \text{?} ( a , b ) + \frac{1}{\vert B \vert} {\sum }_{b ∈ B} {min}_{a ∈ A} d \text{?} ( a , b )$$

$$\text{?} \text{indicates text missing or illegible when filed}$$

To find the nearest points, the Doppler metric shown previously is preferably used. When calculating the Chamfer distance, the feature metric is then also calculated.

With the definition:

$${b}^{*} ( a ) = {arg min}_{b ∈ B} {d}^{doppler} ( a , b )$$

$${a}^{*} ( b ) = {arg min}_{a ∈ A} {d}^{doppler} ( a , b )$$

the Chamfer distance can thus be calculated, with:

$$δ \text{?} ( A , B ) = \frac{1}{\vert A \vert} {\sum }_{a ∈ A} {d}^{doppler} ( a , {b}^{*} ( a ) ) + d \text{?} ( a , {b}^{*} ( a ) ) + \frac{1}{\vert B \vert} {\sum }_{b ∈ B} {d}^{doppler} ( {a}^{*} ( b ) , b ) + d \text{?} ( {a}^{*} ( b ) , b )$$

$$\text{?} \text{indicates text missing or illegible when filed}$$

It is advantageous here if the geometric and Doppler dimensions are used to determine the nearest points. The further attributes, which are often more noisy, are preferably taken into account, but have less influence. This makes the Chamfer distance metric more robust against noisy attributes of individual points.

Analogously to the Chamfer distance metric, the proposed metrics can be used to calculate the Hausdorff distance. There are several options.

The Hausdorff distance results as:

$$δ \text{?} ( A , B ) = max \{ {max}_{a ∈ A} {d}^{doppler} ( a , {b}^{*} ( a ) ) , {max}_{b ∈ B} {d}^{doppler} ( {a}^{*} ( b ) , b ) \}$$

$$\text{?} \text{indicates text missing or illegible when filed}$$

Analogously, the following can be defined:

$${b}_{total}^{*} ( a ) = {max}_{b ∈ B} {d}^{total} ( a , b )$$

$${a}_{total}^{*} ( n ) = {max}_{a ∈ A} {d}^{total} ( a , b )$$

The Hausdorff distance can then be calculated with:

$$δ \text{?} ( A , B ) = max \{ {max}_{a ∈ A} {d}^{total} ( a , {b}_{total}^{*} ( a ) ) , {max}_{b ∈ B} {d}^{total} ( {a}_{total}^{*} ( b ) , b ) \}$$

$$\text{?} \text{indicates text missing or illegible when filed}$$

The Doppler metric is now used to find the nearest points. Afterwards, the feature metric is additionally calculated with the corresponding points and is used in the Hausdorff distance.

This defines:

$$\tilde{a} = {arg min}_{a ∈ A} {d}^{doppler} ( a , {b}^{*} ( a ) )$$

$$\tilde{b} = {arg min}_{b ∈ B} {d}^{doppler} ( {a}^{*} ( b ) , b )$$

The Hausdorff distance can then be calculated with:

$$δ \text{?} ( A , B ) = max \{ {d}^{doppler} ( \tilde{a} , {b}^{*} ( \tilde{a} ) ) + {d}^{feat} ( \tilde{a} , {b}^{*} ( \tilde{a} ) ) , {d}^{doppler} ( {a}^{*} ( \tilde{b} ) , \tilde{b} ) + {d}^{feat} ( {a}^{*} ( \tilde{b} ) , \tilde{b} ) \}$$

$$\text{?} \text{indicates text missing or illegible when filed}$$

Analogously to the Chamfer distance, this definition makes the Hausdorff distance more robust against noisy attributes of points to which a distance is to be calculated.

In a further aspect of the present invention, a control device is also provided which is comprised in a vehicle having an autonomous driving function and/or a robotic system and/or an industrial machine and on which the present trained machine learning model for object detection can be executed.

In a further aspect of the present invention, a computer program having program code is provided for carrying out at least parts of the present method in one of its aspects when the computer program is executed on a computer. In other words, a computer program (product) comprising instructions which, when the program is executed by a computer, cause the computer to carry out the method/the steps of the method in one of its aspects.

In a further aspect of the present invention, a computer-readable data carrier having program code of a computer program is proposed for carrying out at least parts of the present method in one of its aspects when the computer program is executed on a computer. In other words, the present invention relates to a computer-readable (memory) medium comprising instructions which, when executed by a computer, cause the computer to carry out the method/the steps of the method in one of its aspects.

The method and/or the device of the present invention can be used to optimize a loss function during training of models, in particular generative models, in particular variable autoencoders or autoencoders for point clouds, or to minimize a corresponding loss (loss value). The method and/or the device of the present invention can be used to calculate a reconstruction loss for point cloud data used for training. Such autoencoders can also be used to generate synthetic data. Such autoencoders can also be used to learn a good data representation in the latency space of radar and/or lidar point clouds.

Such a latency space can preferably be used in turn to train other neural networks. For this purpose, the latency space is preferably used as ground truth and thus preferably serves as a representation that another machine learning model is to learn. Such a machine learning model can for example also be trained by masked modeling. An encoder of the autoencoder can also be used together with another neural network, in particular as the head thereof, to solve a specific task, such as object detection or semantic segmentation. Since the encoder is preferably pre-trained, this makes training the entire neural network much easier. The present invention can also be used to evaluate the quality and/or similarity of point clouds, for example generated point clouds and real measured point clouds.

The present invention can be used to train a neural network intended to generate a denser point cloud from a given point cloud. The point clouds of a radar and/or lidar sensor are preferably used as input data. Furthermore, for example, another optical sensor with a comparatively higher resolution (e.g. a high-resolution lidar and/or radar sensor) can provide a denser point cloud. The neural network is then preferably trained so that it predicts the denser point cloud from the input data. For this purpose, it is preferable for the given, denser point cloud and the predicted point cloud to be compared. This comparison is preferably included in the training loss. The present method and/or the device can be used for this purpose. The present invention can also be applied to point clouds of ultrasonic sensors, for example when said sensors detect a Doppler velocity.

The method and/or the device of the present invention can be used to analyze data originating from a sensor. The sensor can ascertain measurements of the environment in the form of sensor signals, for example originating from radar, lidar, and/or ultrasonic sensors. The method and/or the device of the present invention can be used to analyze specific data, namely sensors that can measure the Doppler velocity.

The method and/or the device of the present invention can be used for anomaly detection. The present method and/or the device can be used in particular to detect anomalies in a technical system. This is because the present invention provides a new and improved method for training an autoencoder, in particular in an unsupervised manner. The autoencoder trained in this way can then be used to detect anomalies by labeling input data as anomalous if the reconstruction of said data, i.e. the output of the input data provided by the autoencoder, differs sufficiently from the input data, in particular depending on a boundary criterion.

The trained encoder of an autoencoder can be trained in combination with an additionally trained head. Such a network can be used to calculate a control signal to control a technical system, such as a computer-controlled machine, such as a robotic system, a vehicle, a household appliance, a power tool, a manufacturing machine, or an access control system. Such a network can be used to generate a control signal to control an information transmission system, such as a monitoring system based on radar and/or lidar sensor data.

In this context, the method and/or the device of the present invention can be used for measuring and/or controlling. The present method and/or the device can also be used to analyze data (e.g. scalar time series) that can be generated in particular by a radar or lidar sensor, and to operate the technical system based on the analysis. Furthermore, the present method and/or the device can be used to ensure fail-safe operation of a technical system, in particular to detect anomalies and to subsequently operate the technical system in a safe mode. The present method and/or the device relates in particular to the training of an in particular generative model. The present method and/or the device is a method for validating a model, in particular a generative model, for example by enabling comparison of generated point clouds with reference point clouds.

A machine learning model trained in this way can then, of course, be used for a large number of applications.

The described embodiments and developments of the present invention can be combined with one another as desired.

Further possible embodiments, developments, and implementations of the present invention also include combinations not explicitly mentioned of features of the present invention described above or in the following relating to the exemplary embodiments of the present invention.

### BRIEF DESCRIPTION OF THE DRAWINGS

The figures are intended to impart further understanding of the embodiments of the present invention. They illustrate example embodiments of the present invention and, in connection with the description, serve to explain principles and concepts of the present invention.

Other embodiments and many of the mentioned advantages are apparent from the figures. The illustrated elements of the figures are not necessarily shown to scale relative to one another.

FIG. 1 shows a schematic flow diagram of an exemplary embodiment of a method according to the present invention.

FIG. 2 shows a schematic block diagram of a machine learning model.

FIG. 3 shows an example of a distance measurement between two points.

### DETAILED DESCRIPTION OF EXAMPLE EMBODIMENTS

In the figures, identical reference signs denote identical or functionally identical elements, parts or components, unless stated otherwise.

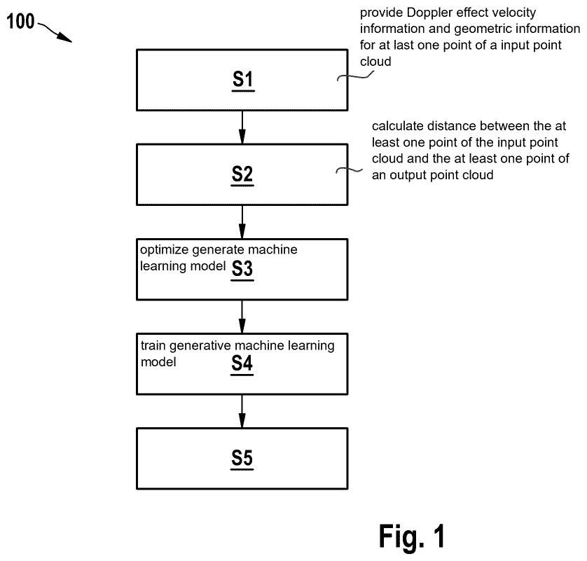

FIG. 1 shows a schematic flow diagram of a method for training a machine learning model, in particular a generative machine learning model.

In any embodiment, the method can be carried out, at least in part, by a device 100, which, for this purpose, can comprise a plurality of components not shown in more detail, for example one or more provisioning units and/or at least one evaluation and computing unit. It is self-evident that the provisioning unit can be designed together with the evaluation and computing unit or can be different therefrom. Furthermore, the device 100, which can be part of a system, can comprise a storage unit and/or an output unit and/or a display unit and/or an input unit.

The computer-implemented method comprises at least the following steps:

In a step S1, Doppler effect velocity information and geometric information are provided for at least one point of an input point cloud, on the basis of which the machine learning model (200) generates at least one point of an output point cloud, wherein Doppler effect velocity information and geometric information are assigned to the at least one point of the output point cloud.

In a step S2, a distance between the at least one point of the input point cloud and the at least one point of the output point cloud is calculated on the basis of the corresponding Doppler effect velocity information and the corresponding geometric information.

In a step S3, the machine learning model, in particular a generative machine learning model, is optimized by optimizing a cost function by using a metric that incorporates the calculated distance, and optionally by using the Doppler effect velocity information.

In a step S4, the trained, in particular generative, machine learning model is provided.

The generative machine learning model is preferably trained to compare a plurality of input point clouds with each other, wherein the input point clouds, in particular a similarity between the input point clouds, can be evaluated on the basis of the calculated distance.

The machine learning model, in particular generative machine learning model, is preferably trained to generate and/or predict at least one further point cloud on the basis of an input reference point cloud, wherein the generation and/or prediction of the further point cloud is carried out on the basis of the metric incorporating the calculated distance.

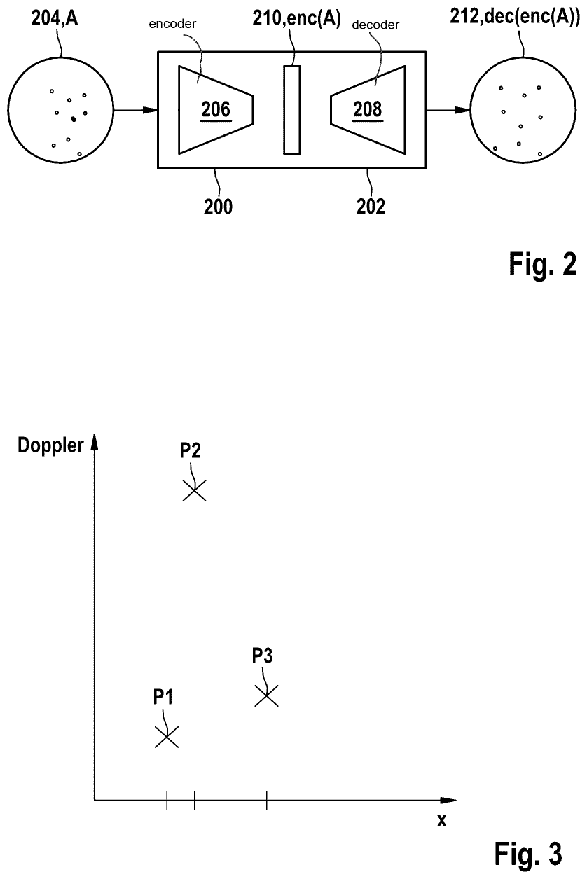

FIG. 2 schematically shows a schematic block diagram with a machine learning model 200, in particular a generative machine learning model. The generative machine learning model 200 comprises an autoencoder 202 that processes an input point cloud 204, A. The autoencoder 202 comprises an encoder 206 and a decoder 208. The encoder 206 generates encoded data 210 (enc (A)) based on the data of the input point cloud 204, which encoded data are then decoded again by the decoder 208 in order to ascertain decoded data of an output point cloud 212, dec (enc (A)). The goal is to train the autoencoder 202 such that dec (enc (A))≈A applies. The encoder 206 thus encodes the input data 204, A to form enc (A). The decoder 208 decodes the data dec (enc (A)). The result should approximately correspond to the original input data A. To compare dec (enc (A)) with A, the metric incorporating the currently calculated distance is used, which metric can compare the point clouds 204, 212 with each other. This is beneficial both for training and for evaluating the model.

FIG. 3 shows a schematic view of three points P1, P2, P3. For better illustration and simplicity, two dimensions are shown. However, the following also applies analogously to more than two dimensions. The three points P1, P2, P3 have different coordinates in a coordinate system, each with dimensions x as well as different Doppler effect velocity information (Doppler for short).

Previous approaches have used only the dimension(s) x (y, z) between two points to calculate the distance. If the closest point to P1 is sought on this basis, the result is P2. If, based on this distance, a difference is then ascertained between the corresponding Doppler effect velocity information, this leads to a very large value for this deviation, since the Doppler effect velocity information of P2 and P1 differs greatly. This can have a detrimental effect, for example when training a neural network.

The presently proposed method of the present invention can overcome this problem because the proposed method uses both the dimension information x and the Doppler effect velocity information (Doppler) to calculate the nearest point to a reference point. The nearest point to P1 in this case is P3, since although it has a slightly greater distance in x than P2, it has a substantially smaller difference in Doppler to P1. The presen method thus identifies P3 as the nearest point to P1. This is particularly advantageous for training neural networks on point clouds where the similarity between two point clouds is to be calculated. The proposed metric can be used to calculate a more reliable measure of the similarity between two point clouds. The proposed metric can be used in a Chamfer distance or Hausdorff distance correspondingly extended by the Doppler effect velocity information. The metric can be used for training machine learning models, in particular generative machine learning models, for point clouds by using it in the training loss.

1-13. (canceled)

14. A method for training a generative machine learning model for object detection, the method comprising the following steps:
providing Doppler effect velocity information of a relative radial velocity of at least one point of an input point cloud of an object to be detected, measured in relation to a detecting sensor, and geometric information about the at least one point of the input point cloud, wherein the machine learning model generates at least one point of an output point cloud based on the Doppler effect velocity information and the geometric information of the at least one point of the input point cloud, and wherein Doppler effect velocity information of the relative radial velocity of the at least one point of the object to be detected, measured in relation to the detecting sensor, and geometric information are assigned to the at least one point of the output point cloud;
calculating a distance between the at least one point of the input point cloud and the at least one point of the output point cloud based on the Doppler effect velocity information and the geometric information of the at least one point of the input point cloud, and the Doppler effect velocity information and the geometric information of the at least one point of the output point cloud;
optimizing the generative machine learning model by optimizing a cost function by using a metric incorporating the calculated distance; and
providing the trained machine learning model for object detection.

15. The method according to claim 14, wherein the Doppler effect velocity information and the geometric information of the at least one point of the input point cloud are: (i) detected by an optical sensor that is movable relative to the object, the optical including a lidar sensor or a radar sensor or an ultrasonic sensor, and/or (ii) generated by synthetic data generation.

16. The method according to claim 14, wherein the geometric information of the at least one point of the input point cloud and the geographic information of the at least one point of the output point cloud include: (i) information about Cartesian coordinates of the at least one point of the input cloud point and of the at least one point of the output cloud point, respectively and/or (ii) information about a subset of the Cartesian coordinates of the of the at least one point of the input cloud point and of the at least one point of the output cloud point, respectively and/or (iii) information about a distance from an optical sensor and/or (iv) information about an azimuth angle and/or elevation angle.

17. The method according to claim 14, wherein the generative machine learning model includes a variable autoencoder and/or an autoencoder for point clouds.

18. The method according to claim 14, wherein:
the machine learning model is trained to compare a plurality of input point clouds with each other, wherein a similarity between the input point clouds can be evaluated based on the calculated distance, and/or
the machine learning model is trained to generate and/or predict at least one further point cloud based on an input reference point cloud, wherein the generation and/or prediction of the further point cloud is carried out based on the metric incorporating the calculated distance.

19. The method according to claim 14, wherein the metric is based on a Chamfer distance metric or a Hausdorff distance metric.

20. The method according to claim 14, wherein the calculation of the distance between the between the at least one point of the input point cloud and the at least one point of the output point cloud is further carried out based on further features including a reflection intensity or a radar cross section.

21. The method according to claim 14, wherein: (i) the Doppler effect velocity information and the geometric information about the at least one point of the input point cloud are provided from a home vehicle, or (ii) the Doppler effect velocity information of the at least one ppint of the input point cloud is preprocessed such that the Doppler effect velocity information of the at least one point of the input point cloud is compensated for by a movement of the home vehicle, or (iii) the Doppler effect velocity information of the at least one point of the input point cloud is preprocessed such that the Doppler effect velocity information of the at least one point of the input point cloud is divided into at least two velocity components of the home vehicle.

22. The method according to claim 14, wherein the Doppler effect velocity information and geometric information of the at least one point of the input point cloud are normalized.

23. A non-transitory computer-readable data carrier on which is stored program code of a computer program for training a generative machine learning model for object detection, the program code, when executed by a computer, causing the computer to perform the following steps:
providing Doppler effect velocity information of a relative radial velocity of at least one point of an input point cloud of an object to be detected, measured in relation to a detecting sensor, and geometric information about the at least one point of the input point cloud, wherein the machine learning model generates at least one point of an output point cloud based on the Doppler effect velocity information and the geometric information of the at least one point of the input point cloud, and wherein Doppler effect velocity information of the relative radial velocity of the at least one point of the object to be detected, measured in relation to the detecting sensor, and geometric information are assigned to the at least one point of the output point cloud;
calculating a distance between the at least one point of the input point cloud and the at least one point of the output point cloud based on the Doppler effect velocity information and the geometric information of the at least one point of the input point cloud, and the Doppler effect velocity information and the geometric information of the at least one point of the output point cloud;
optimizing the generative machine learning model by optimizing a cost function by using a metric incorporating the calculated distance; and
providing the trained machine learning model for object detection.

24. A control device situated in a vehicle having an autonomous driving function and/or a robotic system and/or an industrial machine, and on which a trained generative machine learning model for object detection can be executed, the generative machine learning model being trained by:
providing Doppler effect velocity information of a relative radial velocity of at least one point of an input point cloud of an object to be detected, measured in relation to a detecting sensor, and geometric information about the at least one point of the input point cloud, wherein the machine learning model generates at least one point of an output point cloud based on the Doppler effect velocity information and the geometric information of the at least one point of the input point cloud, and wherein Doppler effect velocity information of the relative radial velocity of the at least one point of the object to be detected, measured in relation to the detecting sensor, and geometric information are assigned to the at least one point of the output point cloud;
calculating a distance between the at least one point of the input point cloud and the at least one point of the output point cloud based on the Doppler effect velocity information and the geometric information of the at least one point of the input point cloud, and the Doppler effect velocity information and the geometric information of the at least one point of the output point cloud;
optimizing the generative machine learning model by optimizing a cost function by using a metric incorporating the calculated distance; and
providing the trained machine learning model for object detection.

25. A device for training a generative machine learning model, comprising:
an evaluation and computing device configured to carry out the following steps:
providing Doppler effect velocity information of a relative radial velocity of at least one point of an input point cloud of an object to be detected, measured in relation to a detecting sensor, and geometric information about the at least one point of the input point cloud, wherein the generative machine learning model generates at least one point of an output point cloud based on the Doppler effect velocity information of the at least one of the input point cloud and/or the geometric information of the at least one input point cloud, wherein Doppler effect velocity information of the relative radial velocity of the at least one point of the object to be detected, measured in relation to the detecting sensor, and geometric information are assigned to the at least one point of the output point cloud;
calculating a distance between the at least one point of the input point cloud and the at least one point of the output point cloud based on the Doppler effect velocity information and the geometric information of the at least one point of the input point cloud, and the Doppler effect velocity information and the geometric information of the at least one point of the output point cloud;
optimizing the generative machine learning model by optimizing a cost function by using the calculated distance; and
providing the trained machine learning model.

26. The method according to claim 14, wherein the optimizing of the cost function is further by using the Doppler effect velocity information of the at least one point of the input point cloud and the the Doppler effect velocity information of the at least one point of the output point cloud.

27. The non-transitory computer-readable data carrier according to claim 23, wherein the optimizing of the cost function is further by using the Doppler effect velocity information of the at least one point of the input point cloud and the the Doppler effect velocity information of the at least one point of the output point cloud.

28. The control device according to claim 24, wherein the optimizing of the cost function is further by using the Doppler effect velocity information of the at least one point of the input point cloud and the the Doppler effect velocity information of the at least one point of the output point cloud.

29. The device according to claim 25, wherein the optimizing of the cost function is further by using the Doppler effect velocity information of the at least one point of the input point cloud and the the Doppler effect velocity information of the at least one point of the output point cloud.
